(19) United States
(12) Patent Application Publication
(10) Pub. No.: US 2009/0207597 A1
(43) Pub. Date: Aug. 20, 2009

(54) Rechargeable Light Assembly

(76) Inventor: Norman L. Silver, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/034,166

(22) Filed: Feb. 20, 2008

(51) Int. Cl. F21L 4/00

(52) U.S. Cl. 362/183

(57) ABSTRACT

A rechargeable light assembly which includes a lamp module and a support rod sub-assembly can provide illumination while installed as a walkway light on the ground. The same lamp module may also be used as an illumination device when the lamp module is removed from the support rod sub-assembly. While the lamp module is mounted on the support rod sub-assembly, a recharging power source attached to the support rod sub-assembly charges an electrical storage device inside the lamp module. Removal of the lamp module from the support rod sub-assembly still permits use of the lamp module as a portable lighting device.

### FIELD OF THE INVENTION

The present invention relates generally to portable rechargeable solar lights which may be used in residential or commercial settings. More specifically the invention relates to a light configured so that it may be used not only outdoors in a lawn, yard or garden, but also for illumination indoors.

### BACKGROUND OF THE INVENTION

Walkway lights have long been known for providing illumination of sidewalks, driveways, lawns, etc. These lights may be powered through underground wiring, gas supply, external battery power, or more recently, solar power. Whatever the power source, these lights typically operate as a single unit and the lamp portion is not readily removed from the power source, (i.e. solar array) or the physical support that the light sits on. This restricts the illumination of the light to the immediate area surrounding where the light was placed and prevents the light from being portable.

This restriction is found in existing solar lighting, for example. Existing solar lighting devices, such as solar powered walkway-type lights, have an electrical storage device which is charged by a solar cell array. These electrical storage devices, such as batteries or capacitors, are placed in close proximity to the solar cell array and are not easily removable. Examples of solar powered lights include walkway-type lights that are rigidly fixed to support rods or posts on which they are mounted. Generally, if a user desires to move the solar-powered walkway-type lights to a different location, the user must move the entire walkway-type light unit, including its physical support structure, as a whole assembly. The lamp portion of the walkway-type light cannot be moved without also moving the solar cell array, electrical storage device, and physical support rod along with the lamp. Furthermore, when moving the light, a user must reposition the entire assembly in an outdoor sun-illuminated location in order to recharge the batteries. The user cannot easily transfer the light indoors even when the light is previously charged in sunlight. Such restrictions on use have prevented the portability of solar lights.

### SUMMARY OF THE INVENTION

Briefly, in one embodiment, the present invention provides a rechargeable light module which may be charged in sunlight while on a support rod in a lawn or garden, but which may also be used to illuminate other areas at the user's option, even indoors where solar energy is not normally available. This flexibility is achieved because the invention allows the lamp to illuminate even if not connected to its solar cell array and support rod. Aspects of the invention allow the user to remove and replace the lamp module away and disconnected from the support rod and recharging solar cell array with ease.

One embodiment of the invention realizes a light assembly which includes a rechargeable light module including rechargeable battery, a light emitting diode, and a light diffuser attached to a support rod. The support rod supports both the light module and the recharging mechanism, such as a solar cell array. In one aspect, the lamp illuminates when connected to the support rod and recharging mechanism. The lamp module also illuminates when removed and disconnected from the support rod and recharging mechanism.

In a still another aspect of the invention, a method is described for illuminating a light assembly which includes connecting a lamp module to a support rod and recharging mechanism. The lamp module includes a housing base which contains a light emitting diode and a rechargeable electrical storage device which powers the light emitting diode. The method further includes separating the lamp from the support rod and recharging mechanism, and then using the lamp as a portable illuminating device.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1A illustrates an example assembled view of a rechargeable light assembly in accordance with one embodiment of the present invention;

FIG. 1B illustrates an example view of the rechargeable light assembly when the lamp module is removed from the support rod and recharging power source, in accordance with an embodiment of the present invention;

FIG. 2 illustrates an example pre-assembly, exploded view of the lamp module subassembly in accordance with an embodiment of the present invention;

FIG. 3 illustrates an example pre-assembly, exploded view of a rechargeable light assembly in accordance with an embodiment of the present invention;

FIG. 4 depicts a flow diagram showing steps performed to illuminate the lamp module of a rechargeable light in accordance with an embodiment of the present invention.

### DETAILED DESCRIPTION OF ILLUSTRATIVE EMBODIMENTS

One embodiment of the present invention includes a novel design for a walkway-type light that that allows the lamp portion of the walkway-type light to illuminate when removed from its support rod and thus electrically disconnected from its recharging power source. The lamp portion (lamp module sub-assembly) can easily be removed and reattached to its recharging power source and support rod multiple times. The support rod design element of the walkway-type light allows easy installation in yards, garden, walkways and other such areas whether residential or commercial. The portable lamp module sub-assembly is designed to contain all the features needed to illuminate even when not attached to the support rod and when separated from the recharging power source which is an integral part of the support rod. The lamp module sub-assembly is designed to sit evenly on a flat surface, such as on a piece of outdoor furniture such as a picnic table in a portable fashion separate from its support rod sub-assembly.

In one embodiment, the recharging power source is an array of solar cells attached to the support rod. In another embodiment, the recharging power source may be a power supply, such as a standard AC line-voltage (typically 120 V AC) to DC power transformer that is attached to the support rod. In yet another embodiment, the recharging power source may be an external battery that provides recharging power via the support rod. Solar powered garden lights are known in the art, but none feature the ability to detach a lamp module sub-assembly from its support rod and which also separates and electrically disconnects the recharging power source and continue operational use of the lamp sub-assembly as a portable illumination component. One aspect of the present invention is the location of the rechargeable electrical storage device, such as a battery, housed next to the light emitting component within the removable lamp module sub-assembly, and not fixed on the support rod which provides mechanical support to the rechargeable power source when the lamp module sub-assembly is detached.

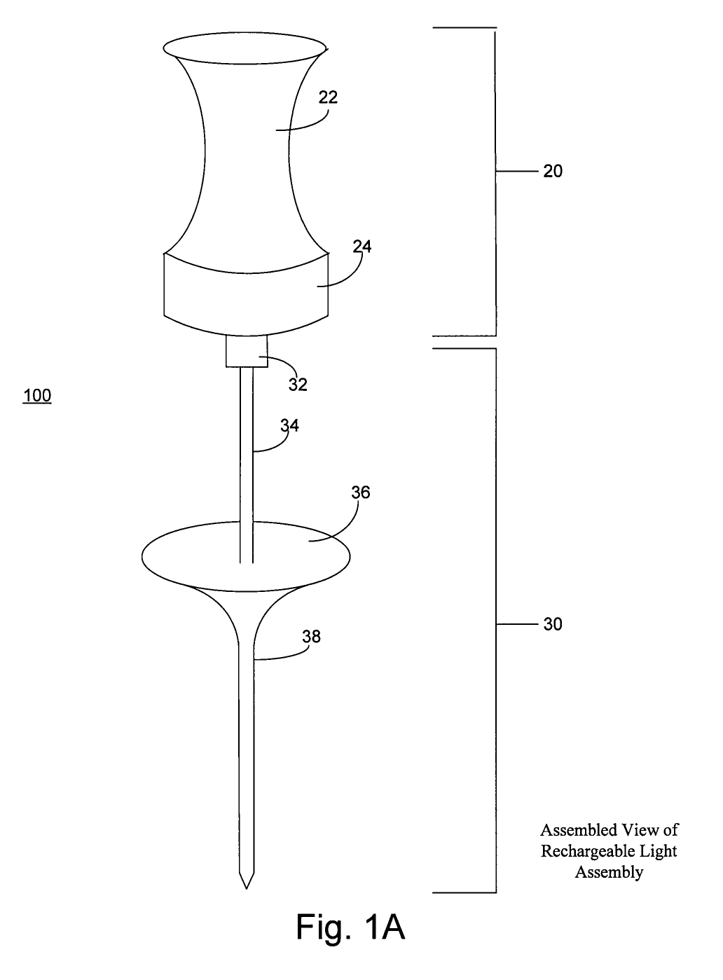

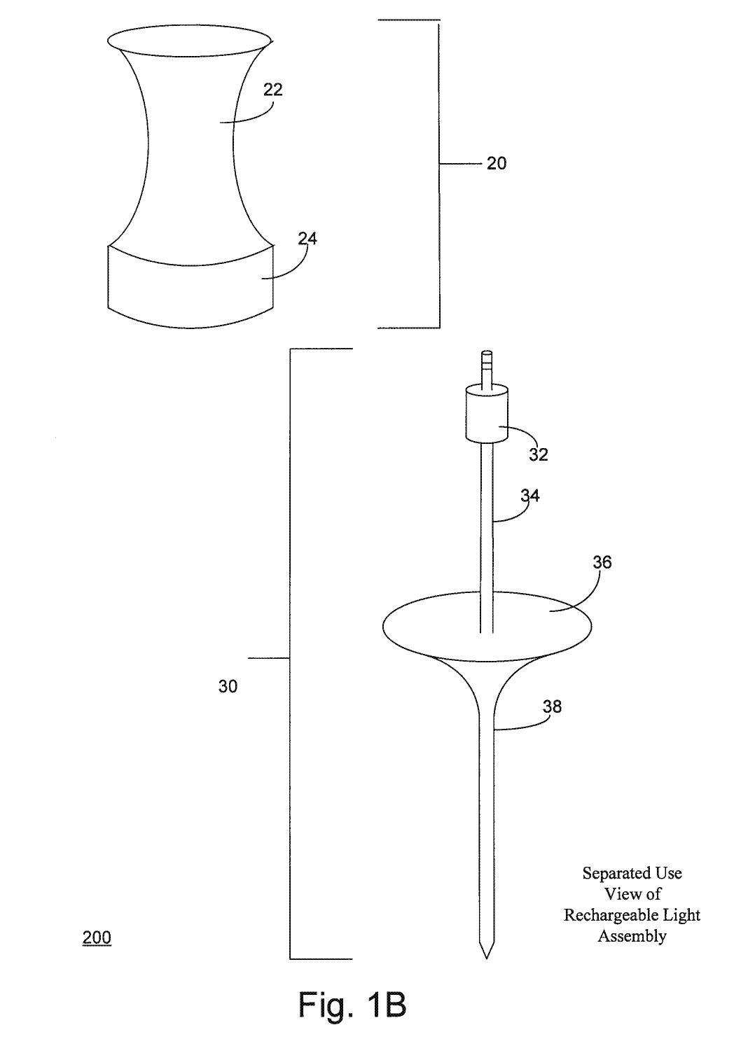

FIG. 1A illustrates one embodiment of the current invention. A removable lamp module 20 sits atop a support rod sub-assembly 30 that contains the rechargeable power source 36. The lamp module includes within its housing 24 a light emitting component and a rechargeable electrical storage device. In one embodiment, the lamp module may also contain a translucent lens 22, which may act as a diffuser, in esthetically pleasing shapes, sitting atop the housing base 24. The lens 22 disperses the light emitted by the light emitting component. In one embodiment of the invention, the housing is constructed out of plastic, but in other embodiments it may be constructed out of wood, metal, ceramic or other such material.

The support rod sub-assembly 30 connects to the lamp module via an electrical connector 32. The support rod contains an upper portion 34 and a lower portion 38, with the recharging power source 36 between them in a typical embodiment of the invention. The support rod may be composed of a variety of materials, including metal, wood or plastic. Furthermore, in one embodiment of the invention, the support rod sub-assembly lower portion 38 may be in the shape of a stake, where the distal end of the stake is sharp enough to penetrate the ground, after which the invention remains balanced and standing, typically without the need for external support. In another embodiment of the invention, (not shown) the support rod mounts to a platform which attaches to the lower portion (distal end) of the rod. In yet another embodiment of the invention, (not shown) the support rod's distal end may have a mechanical base or feet connected to the lower portion, allowing the invention to remain balanced and standing, typically without the need for external support. In still another embodiment of the invention, the support rod's distal end may connect to a mounting cleat, after which the invention may remain standing at a variety of angles after mounting to a surface having a corresponding mating interface.

In a typical embodiment, as shown in the figures, recharging electrical power runs from the recharging power source through the upper portion of the support rod to the electrical connector and on to the lamp module when the module is attached to the support rod sub-assembly. In one embodiment of the invention, the lamp module may operate while attached to the support rod sub-assembly having the recharging power source. The lamp module may also operate when removed from the support rod sub-assembly and electrically disconnected from recharging power source which remains on the support rod sub-assembly, as described more fully below.

FIG. 1B depicts one embodiment 200 of another operational mode of the configuration of FIG. 1A. As described above and as depicted in FIG. 1B, the lamp module 20 may illuminate when not connected to the support rod sub-assembly 30. This mode of operation, where the lamp module is separated, without interconnecting wires, from the support rod sub-assembly, is a portable mode of operation. In the portable mode, the lamp module operates to illuminate when physically separated and electrically disconnected from the support rod sub-assembly. Thus, the lamp module 20 is operational when electrically disconnected from the recharging power source. In the embodiment of FIG. 1B, the recharging power source 36 (e.g. a solar cell array), is an integral part of the support rod sub-assembly. The recharging power source remains with the support rod sub-assembly when the lamp module 20 is separated from the support rod sub-assembly. The housing base 24 is designed to internally hold one or more rechargeable electrical storage devices (e.g. batteries or capacitors) which serve to power the lamp module 20 when disconnected from the support rod sub-assembly. The housing base also allows the lamp to sit evenly on any solid level surface, typically a piece of indoor or outdoor furniture such as a table. Generally, any solid level surface may be used, whether indoor furniture such as a kitchen table or shelf, or outdoor furniture, such as a picnic table or outdoor stand.

FIG. 1B also depicts one embodiment of the electrical connector. In the typical embodiment of the invention, the electrical connector 32 on the support rod sub-assembly 30 will be a male connector, and will attach to a female connector 28 located in the housing of the lamp module 20. In another embodiment, (not shown) the electrical connector on the support rod sub-assembly will be a female connector, and will attach to a recessed male connector located in the housing base 24 of the lamp module 20. The male connector is preferably recessed to allow the lamp module to sit evenly on any solid level surface, as described above. In addition, the male connector will be recessed in such as way as to preserve its electrical operability and well as to allow safe use of the lamp by users. In general, the electrical connector provides both an electrical connection as well as a mechanical connection between the support rod sub-assembly 30 and the lamp module sub-assembly 20. The electrical connector may take any form known to those of skill in the art.

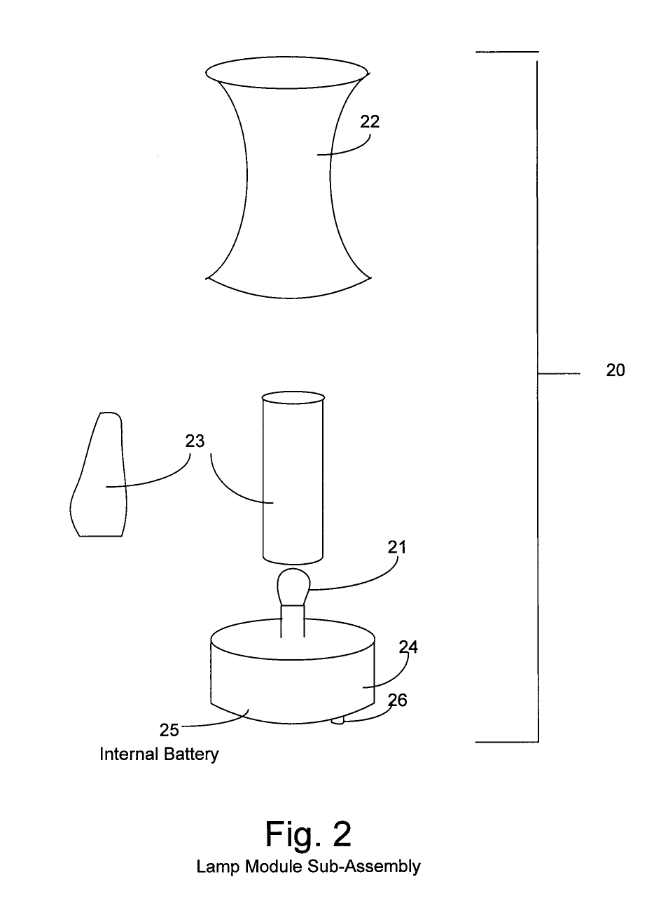

FIG. 2 depicts a more detailed view of one embodiment of the lamp module subassembly 20. The light emitting component 21 sits atop the housing base 24. The light emitting component may be a light emitting diode (LED), a neon light, an incandescent bulb, a halogen bulb, a fluorescent bulb, an electroluminescent panel or other such lighting components. Such lighting components may have visual attributes such as constant or variable color and flicker. The housing base may be made of any suitable, durable material, such as plastic, glass, ceramic, cardboard, a polymer, wood, fiberglass, or any other materials that are durable and able to be shaped into the base form. An electrical storage device 25 is contained within the housing and is electrically connected to and provides power for the light emitting device. The electrical storage device may be a battery, a capacitor, a storage cell, or other such storage devices.

In one embodiment of the invention, a switch 26 is included allowing the user to control the illumination of the light emitting device. The switch may be a toggle or rocker switch, a push button, membrane switch a slide or wheel-type dimmer switch, or other varieties of switches known in the art. In other alternative embodiments, the switch may be a switch that is actuated by any of a timer, a sound sensor, a motion sensor, a light sensor, or a touch sensor. In one embodiment, the switch 26 may be a multiple position switch that allows a user to select from one of many colors, such as white, red, yellow, or green, and one or more visual effects such as a fixed light source or flicker to simulate a candle.

A diffuser or other type of lens 22 is assembled to connect to the top outer portion of the housing base 24. The diffuser or lens can refract and disperse the light emitted by the light emitting component 21. The diffuser or lens may be concave, as shown in FIG. 2, convex or flat. The diffuser or lens may be fabricated using any transparent material such as clear plastic, translucent or clear polymers (such as acrylic), glass, crystal, wax, or other suitable materials. An optional translucent light member 23 may typically sit within a clear lens 22 atop the light emitting component 21. The translucent light member may be in the shape of a tube, a flame, a taper candle, a pillar candle, a votive candle or a geometric candle figure (triangle, pyramid, cylinder, sphere or cone). In the instance of FIG. 2, the specific type of translucent light member shown is a tube and a flame. The translucent light member may be fabricated using any translucent material such as plastic, polymers (such as acrylic), glass, crystal, wax, or other suitable materials.

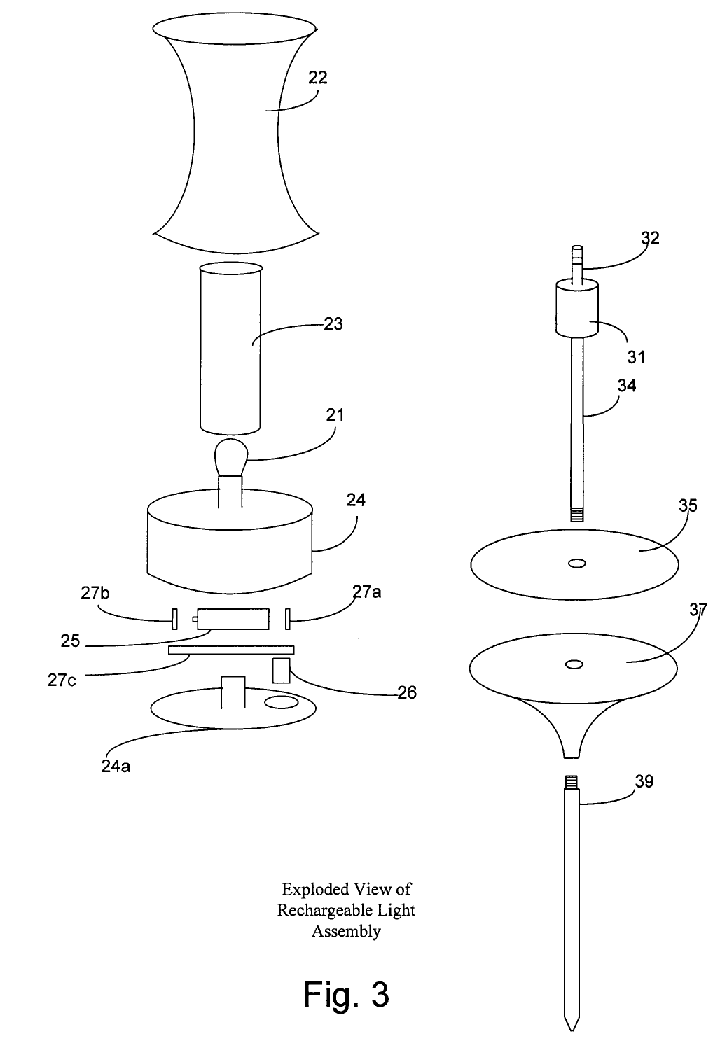

FIG. 3 depicts a more detailed representation of one embodiment of the assembly of parts contained in an example rechargeable light assembly. In one embodiment, a lens 22 connects to the top portion of the housing base 24. A translucent light member 23 sits within the lens 22, and around the light emitting component 21. In the instance of FIG. 3, the specific type of translucent light member shown is a tube. The light emitting component 21 sits atop the housing base 24. An electrical storage device 25 is contained within the housing and is electrically connected to and provides power for the light emitting component, through the use of the electrodes or contacts 27A and 27B. The electrodes or contacts are connected to a printed circuit board 27C with directs the operation of the lamp. As discussed above, in one embodiment of the invention, a switch 26 is included allowing the user to control the illumination of the light emitting component. The switch may be configured to take advantage of the many modes of color and flicker of the light emitting component. The switch connects to the printed circuit card. In one version of this embodiment, the switch 26 is a pushbutton actuation-type switch. A silica-gel cover (not shown) optionally protects the pushbutton switch to allow weatherproof operation. Also, as discussed above, in the typical embodiment of the invention, a female connector, located in the bottom cover of the lamp module sub-assembly 24a, will electrically connect to electrical storage device 25 and to the electrical connector 32 on the support rod sub-assembly 30. The support rod sub-assembly shown includes a male connector 32. The bottom cover 24A is attached to the bottom of the housing base and is secured by three screws (not shown). The bottom cover has cutouts leaving room for the female connector and the switch.

According to the embodiment of FIG. 3, the male connector 32 connects to the upper portion of the support rod 34 via a mechanical connector support 31. The distal end of the upper portion 34 of the support rod assembly connects to the rechargeable power supply 36. The recharging power supply 36 includes a solar cell array 35 and the recharging power supply support unit 37. The recharging power supply support unit 37 is connected to the lower portion of the support rod 39. In the embodiment of FIG. 3, the recharging power supply is a solar cell array 35 which collects solar energy and provides electrical energy to recharge the electrical storage device 25 and supply electrical energy to the light emitting component.

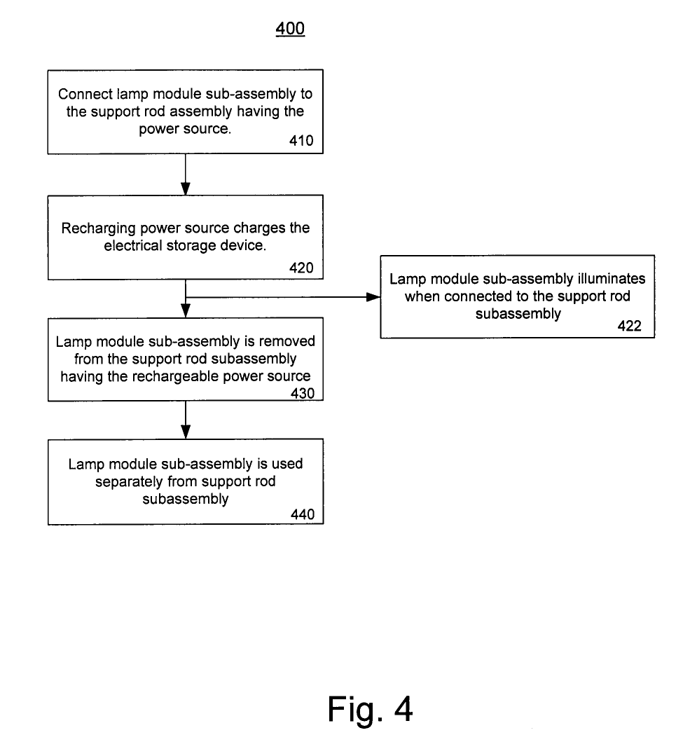

FIG. 4 depicts a method 400 to operate and illuminate a light assembly that includes a lamp module sub-assembly that removably attaches to a support rod sub-assembly and recharging power source. Initially, a user connects the lamp module sub-assembly to the support rod sub-assembly and thereby also electrically connects the electrical storage device to the recharging power source at step 410. The electrical storage device is charged by the recharging power source at step 420. In one embodiment, the electrical storage device is a battery and the recharging power source is a solar cell array panel. In this embodiment, the solar cell array panel will be positioned to capture sunlight and thereby generate electrical power to operate the light emitting component or charge the battery. In other embodiments, recharging power source is standard AC line-voltage to DC power transformer and converter, or alternately, an external battery. In one aspect of the invention, the lamp module sub-assembly may be optionally used while mounted on the support rod sub-assembly at step 422 and as shown in FIG. 1. This type of use may occur as a decorative use of the entire lamp module and support rod assembly as a lighted, decorative display during daylight hours. In another use, such as a low level lighting application, the light assembly is used as walkway lighting in evening or nighttime hours. In the instance where a solar cell array is the recharging mechanism, after some amount of sunlight exposure time, preferably at least after the electrical storage device has fully recharged, the user removes the lamp module sub-assembly from the support rod and the recharging power source at step 430. Then the lamp module sub-assembly is used as an illuminating device physically separate from and electrically disconnected from the support rod sub-assembly having the recharging power source. The recharging power source remains with the support rod sub-assembly because the recharging power source is integral to the support rod sub-assembly. The removable lamp module sub-assembly does not contain an integral recharging power source such as a solar cell array. In this mode of operation, the lamp module sub-assembly relies on a charged electrical energy storage device, such as a battery, to provide energy for illumination. The lamp module sub-assembly, when disconnected from the support rod sub-assembly, can be illuminated at any time desirable by the user using the switch. Thus, the flexibility of use of the embodiments of the current invention is realized by the dual use of the lamp module either while the lamp module is mounted to the rod sub-assembly as a entire unit, such as in a conventional walkway light, or in a portable configuration where the lamp module is separated from the rod sub-assembly and used independently from the rod sub-assembly.

These and other advantages of the present invention will be apparent to those skilled in the art from the foregoing specification. Accordingly, it will be recognized by those skilled in the art that changes or modifications may be made to the above described embodiments without departing from the broad inventive concepts of the invention. It should therefore be understood that this invention is not limited to the particular embodiments described herein, but is intended to include all changes and modifications that are within the scope and spirit of the invention.

What is claimed:

1. A rechargeable light assembly comprising:
a. a lamp module comprising:
a light emitting component;
a rechargeable electrical storage device powering the light emitting component; and
a housing base containing the light emitting component and the electrical storage device;
b. a support rod sub-assembly removably attached to the lamp module, wherein the support rod assembly provides mechanical support and electrical connectivity for the lamp module when mounted on the support rod sub-assembly; and
c. a recharging power source for supplying electrical energy to the rechargeable electrical storage device, the recharging power source mounted on the support rod sub-assembly;
wherein the lamp module is operational to illuminate the light emitting component when the lamp module is physically separated and electrically disconnected from the support rod sub-assembly, and wherein the support rod sub-assembly provides mechanical support to the recharging power source both when the lamp module is mounted to the support rod sub-assembly and when the lamp module is physically separated from the support rod sub-assembly.

2. The assembly of claim 1, wherein the lamp module is operational to illuminate the light emitting component when the lamp module is mated to the support rod sub-assembly.

3. The assembly of claim 1, wherein the lamp module is operational to illuminate the light emitting component when the lamp module is mated to the support rod sub-assembly and is not receiving electrical energy from the recharging power source.

4. The assembly of claim 1, wherein the recharging power source comprises a solar cell array mounted to the support rod sub-assembly.

5. The assembly of claim 1, wherein the recharging power source comprises a power converter using standard 120 VAC power.

6. The assembly of claim 1, wherein the recharging power source comprises a power converter using an external battery power source.

7. The assembly of claim 1, wherein the lamp module further comprises a switch which controls the illumination of the light emitting component.

8. The assembly of claim 1, wherein the lamp module further comprises a lens removably attached to the housing base.

9. The assembly of claim 8, wherein the lamp module further comprises a translucent member interior to the lens, the translucent member placed over the light emitting component.

10. The assembly of claim 9, wherein the translucent member comprises a form having one of a tube shape, a frosted tube shape, a flame shape, a frosted flame shape, a taper candle shape, a pillar candle shape, a votive candle shape, and a geometric candle shape.

11. The assembly of claim 1, wherein the support rod sub-assembly further comprises a removable upper portion and a removable lower portion.

12. The assembly of claim 1, wherein the support rod sub-assembly further comprises a connector mounted to an upper portion of the support rod assembly, wherein the connector facilitates an electrical connection between the recharging power source of the support rod sub-assembly and the lamp module.

13. The assembly of claim 12, wherein the electrical connector further comprises a male connector and the lamp module further comprises a female connector.

14. The assembly of claim 12, wherein the electrical connector further comprises a female connector and the lamp module further comprises a recessed male connector.

15. The assembly of claim 1, wherein the light emitting component comprises one of a light emitting diode, a neon light, an incandescent bulb, a halogen bulb, a fluorescent bulb and an electroluminescent panel.

16. The assembly of claim 1, wherein rechargeable electrical storage device comprises at least one of a battery, and a capacitor.

17. The assembly of claim 1, wherein the support rod sub-assembly comprises at least one of a metal rod, a metal stake, a wooden rod, a wooden stake, a plastic rod or a plastic stake.

18. A method of using an outdoor rechargeable light assembly, the method comprising:
a. connecting a lamp module to a support rod sub-assembly, wherein the lamp module comprises a light emitting component, a rechargeable electrical storage device and a housing base, wherein the support rod sub-assembly is removably attached to the lamp module, the support rod sub-assembly comprising a recharging power source which supplies energy to the rechargeable electrical storage device, wherein the support rod sub-assembly mechanically supports and electrically connects to the lamp module;
b. charging the rechargeable electrical storage device via the recharging power source;
b. separating the lamp module from the support rod sub-assembly, wherein the support rod sub-assembly retains the recharging power source after separating; and
c. using the lamp module of the outdoor rechargeable lighting assembly as a portable illuminating device when the lamp module is mechanically separated and electrically disconnected from the support rod sub-assembly.

19. The method of claim 18, wherein the step of connecting a lamp module to a support rod sub-assembly further comprises:
using the lamp module as an illuminating device while the lamp module is connected to the support rod sub-assembly.

20. The method of claim 18, wherein the step of separating comprises separating the lamp module from the support rod sub-assembly having a solar cell array.
